(19) United States
(12) Patent Application Publication
(10) Pub. No.: US 2026/0196711 A1
(43) Pub. Date: Jul. 9, 2026

(54) COMMUNICATION DEVICE AND COMMUNICATION METHOD

(71) Applicant: HTC Corporation, Taoyuan City (TW)

(72) Inventors: Chun-Yih WU, Taoyuan City (TW); Ta-Chun PU, Taoyuan City (TW); Yen-Liang KUO, Taoyuan City (TW)

(73) Assignee: HTC Corporation, Taoyuan City (TW)

(21) Appl. No.: 19/088,257

(22) Filed: Mar. 24, 2025

(30) Foreign Application Priority Data
Jan. 8, 2025 (TW) 114100685

(51) Int. Cl. H01Q 1/27; H01Q 5/30; H01Q 5/50

(52) U.S. Cl. CPC H01Q 1/273; H01Q 5/30; H01Q 5/50

(57) ABSTRACT

A communication device includes a wearable device, a fabric element, and an auxiliary radiation element. The wearable device includes a main radiation element and a signal source. The main radiation element has a feeding point. The feeding point is coupled to the signal source. The auxiliary radiation element is disposed on the fabric element. When the wearable device is integrated with the fabric element, the auxiliary radiation element is adjacent to the main radiation element, such that an antenna structure is formed by the main radiation element and the auxiliary radiation element.

### CROSS REFERENCE TO RELATED APPLICATIONS

This application claims priority of Taiwan Patent Application No. 114100685 filed on Jan. 8, 2025, the entirety of which is incorporated by reference herein.

### BACKGROUND OF THE INVENTION

### Field of the Invention

The invention relates to a communication device, and more particularly, to a communication device and a communication method.

### Description of the Related Art

With the advancements being made in mobile communication technology, mobile devices such as portable computers, mobile phones, multimedia players, and other hybrid functional portable electronic devices have become more common. To satisfy consumer demand, mobile devices can usually perform wireless communication functions. Some devices cover a large wireless communication area; these include mobile phones using 2G, 3G, and LTE (Long Term Evolution) systems and using frequency bands of 700 MHz, 850 MHz, 900 MHz, 1800 MHz, 1900 MHz, 2100 MHz, 2300 MHz, and 2500 MHz. Some devices cover a small wireless communication area; these include mobile phones using Wi-Fi systems and using frequency bands of 2.4 GHz, 5.2 GHz, and 5.8 GHz.

Antennas are indispensable elements for wireless communication. If an antenna for signal reception and transmission has insufficient operational bandwidth, it may degrade the communication quality of the relative mobile device. Accordingly, it has become a critical challenge for designers to design a small-size, wideband antenna structure.

### BRIEF SUMMARY OF THE INVENTION

In an exemplary embodiment, the invention is directed to a communication device that includes a wearable device, a fabric element, and an auxiliary radiation element. The wearable device includes a main radiation element and a signal source. The main radiation element has a feeding point. The feeding point is coupled to the signal source. The auxiliary radiation element is disposed on the fabric element. When the wearable device is integrated with the fabric element, the auxiliary radiation element is adjacent to the main radiation element, such that an antenna structure is formed by the main radiation element and the auxiliary radiation element.

In some embodiments, the wearable device is an XR (Extended Reality) computing device.

In some embodiments, the fabric element is an article of clothing.

In some embodiments, the antenna structure covers a low frequency band and a high frequency band.

In some embodiments, the low frequency band is from 700 MHz to 1000 MHz.

In some embodiments, the high frequency band is from 2400 MHz to 7125 MHz.

In some embodiments, the length of the main radiation element is from 0.125 to 0.5 wavelength of the high frequency band.

In some embodiments, the length of the auxiliary radiation element is from 0.125 to 0.5 wavelength of the low frequency band.

In some embodiments, the main radiation element substantially has a short L-shape.

In some embodiments, the auxiliary radiation element substantially has a long L-shape.

In some embodiments, a coupling gap is formed between the main radiation element and the auxiliary radiation element.

In some embodiments, the width of the coupling gap is from 0.5 mm to 2 mm.

In some embodiments, the wearable device further includes a tuning circuit, and the feeding point is further coupled through the tuning circuit to the signal source.

In some embodiments, the tuning circuit is configured to improve the impedance matching of the antenna structure.

In some embodiments, the wearable device further includes a first conductive connection element coupled to the main radiation element.

In some embodiments, the first conductive connection element is implemented with a metal spring.

In some embodiments, the communication device further includes a second conductive connection element disposed on the fabric element. The second conductive connection element is coupled to the auxiliary radiation element.

In some embodiments, the second conductive connection element is implemented with a metal pad.

In some embodiments, when the wearable device is integrated with the fabric element, the second conductive connection element is coupled to the first conductive connection element.

In another exemplary embodiment, the invention is directed to a communication method that includes the steps of: providing a wearable device, wherein the wearable device includes a main radiation element and a signal source, and the main radiation element has a feeding point coupled to the signal source; disposing an auxiliary radiation element on a fabric element; and when the wearable device is integrated with the fabric element, disposing the auxiliary radiation element adjacent to the main radiation element, such that an antenna structure is formed by the main radiation element and the auxiliary radiation element.

### BRIEF DESCRIPTION OF DRAWINGS

The invention can be more fully understood by reading the subsequent detailed description and examples with references made to the accompanying drawings, wherein:

FIG. 1 is a diagram of a communication device according to an embodiment of the invention;

FIG. 2 is a diagram of a communication device according to an embodiment of the invention;

FIG. 3 is a diagram of a communication device according to an embodiment of the invention; and

FIG. 4 is a flowchart of a communication method according to an embodiment of the invention.

### DETAILED DESCRIPTION OF THE INVENTION

In order to illustrate the foregoing and other purposes, features and advantages of the invention, the embodiments and figures of the invention will be described in detail as follows.

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. The term “substantially” means the value is within an acceptable error range. One skilled in the art can solve the technical problem within a predetermined error range and achieve the proposed technical performance. Also, the term “couple” is intended to mean either an indirect or direct electrical connection. Accordingly, if one device is coupled to another device, that connection may be through a direct electrical connection, or through an indirect electrical connection via other devices and connections.

The following disclosure provides many different embodiments, or examples, for implementing different features of the subject matter provided. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

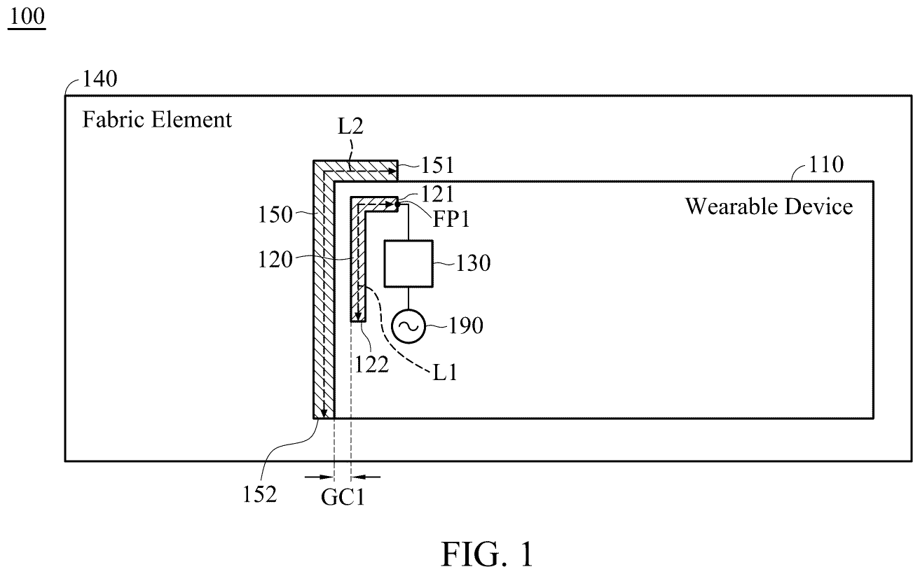

FIG. 1 is a diagram of a communication device 100 according to an embodiment of the invention. In the embodiment of FIG. 1, the communication device 100 at least includes a wearable device 110, a fabric element 140, and an auxiliary radiation element 150. The auxiliary radiation element 150 may be made of a metal material, such as copper, silver, aluminum, iron, or their alloys. It should be understood that the wearable device 110 may include other components, such as a processor, a power supply module, a speaker and/or a housing, although they are not displayed in FIG. 1.

The wearable device 110 may be worn by a user, and it may be fixed on a clothing peripheral component of the user (not shown). In some embodiments, the wearable device 110 is a mobile device, such as a smart phone, a small computer, a VR (Virtual Reality) device, or an AR (Augmented Reality) device. The wearable device 110 at least includes a main radiation element 120 and a signal source 190. The main radiation element 120 may also be made of a metal material. The signal source 190 may be an RF (Radio Frequency) module.

For example, the main radiation element 120 may substantially have a relatively short L-shape. Specifically, the main radiation element 120 has a first end 121 and a second end 122. A feeding point FP1 is positioned at the first end 121 of the main radiation element 120. The second end 122 of the main radiation element 120 is an open end. The feeding point FP1 may also be coupled to the signal source 190. However, the invention is not limited thereto. In alternative embodiment, the wearable device 110 is adjusted, such that the feeding point FP1 is positioned at the second end 122 of the main radiation element 120 and the first end 121 of the main radiation element 120 is an open end.

The auxiliary radiation element 150 is disposed on the fabric element 140. The type and style of the fabric element 140 are not limited in the invention. For example, the fabric element 140 may belong to any part of the clothing peripheral component of the user.

For example, the auxiliary radiation element 150 may substantially have a relatively long L-shape (compared with the main radiation element 120). Specifically, the auxiliary radiation element 150 has a first end 151 and a second end 152. Each of the first end 151 and the second end 152 of the auxiliary radiation element 150 is an open end. That is, the auxiliary radiation element 150 is floating. However, the invention is not limited thereto. In alternative embodiments, the first end 151 or the second end 152 of the auxiliary radiation element 150 is coupled to a ground voltage. The ground voltage may be provided by a system ground plane of the communication device 100 (not shown).

In a preferred embodiment, when the wearable device 110 is integrated with the fabric element 140, the auxiliary radiation element 150 is adjacent to the main radiation element 120, such that an antenna structure is formed by the main radiation element 120 and the auxiliary radiation element 150. For example, a coupling gap GC1 may be formed between the main radiation element 120 and the auxiliary radiation element 150. It should also be noted that the term “adjacent” or “close” over the disclosure means that the distance (spacing) between two corresponding elements is smaller than a predetermined distance (e.g., 10 mm or the shorter), but often does not mean that the two corresponding elements directly touch each other (i.e., the aforementioned distance/spacing between them is reduced to 0).

In alternative embodiments, the wearable device 110 further includes a tuning circuit 130. The feeding point FP1 is further coupled through the tuning circuit 130 to the signal source 190. For example, the tuning circuit 130 may be switchable, and it may include a switch element, one or more capacitors, and one or more inductors (not shown). Generally, the tuning circuit 130 is configured to improve the impedance matching of the antenna structure of the communication device 100. It should be understood that the tuning circuit 130 is merely an optional component, which is omitted in other embodiments.

In other embodiments, each of the main radiation element 120 and the auxiliary radiation element 150 has a different shape, such as a straight-line shape, a meandering shape, a circular shape, a triangular shape, or an elliptical shape, but it is not limited thereto.

In some embodiments, the antenna structure of the communication device 100 can cover a low frequency band and a high frequency band. For example, the low frequency band may be from 700 MHz to 1000 MHz, and the high frequency band may be from 2400 MHz to 7125 MHz. Accordingly, the communication device 100 can support at least the wideband operations of LTE (Long Term Evolution) and WLAN (Wireless Local Area Network).

In some embodiments, the operational principles of the antenna structure of the communication device 100 will be described as follows. The main radiation element 120 can be excited independently, so as to generate the aforementioned high frequency band. Furthermore, the auxiliary radiation element 150 can be excited by the main radiation element 120 using a coupling mechanism, so as to generate the aforementioned low frequency band. With the proposed design of the invention, the wearable device 110 has a function of wireless communication. When the wearable device 110 is integrated with the fabric element 140, the operational bandwidth of the antenna structure of the communication device 100 can be further increased due to the existence of the auxiliary radiation element 150.

In some embodiments, the element sizes of the communication device 100 will be described as follows. The length L1 of the main radiation element 120 may be from 0.125 to 0.5 wavelength (λ/8~λ/2) of the high frequency band of the antenna structure of the communication device 100, such as about 0.25 wavelength (λ/4). The length L2 of the auxiliary radiation element 150 may be from 0.125 to 0.5 wavelength (λ/8~λ/2) of the low frequency band of the antenna structure of the communication device 100, such as about 0.25 wavelength (λ/4). The width of the coupling gap GC1 may be from 0.5 mm to 2 mm, such as about 1 mm. The above ranges of element sizes are calculated and obtained according to many experimental results, and they help to optimize the operational bandwidth and the impedance matching of the antenna structure of the communication device 100.

The following embodiments will introduce different configurations and detail structural features of the communication device 100. It should be understood that these figures and descriptions are merely exemplary, rather than limitations of the invention.

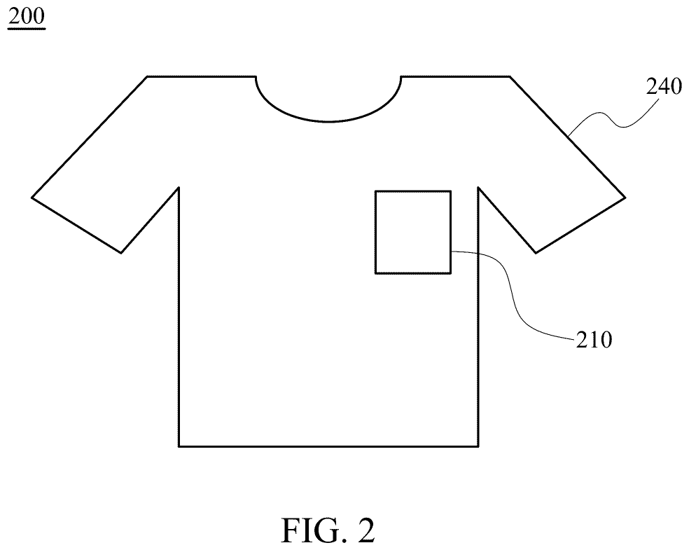

FIG. 2 is a diagram of a communication device 200 according to an embodiment of the invention. FIG. 2 is similar to FIG. 1. In the embodiment of FIG. 2, a wearable device 210 of the communication device 200 is an XR (Extended Reality) computing device, and a fabric element 240 of the communication device 200 is an article of clothing. The wearable device 210 may be fixed on the fabric element 240. For example, the aforementioned article of clothing may be a jacket, a T-shirt, a skirt, or a pair of pants, and it may have a function of heat dissipation. However, the invention is not limited to the above. Other features of the communication device 200 of FIG. 2 are similar to those of the communication device 100 of FIG. 1. Accordingly, the two embodiments can achieve similar levels of performance.

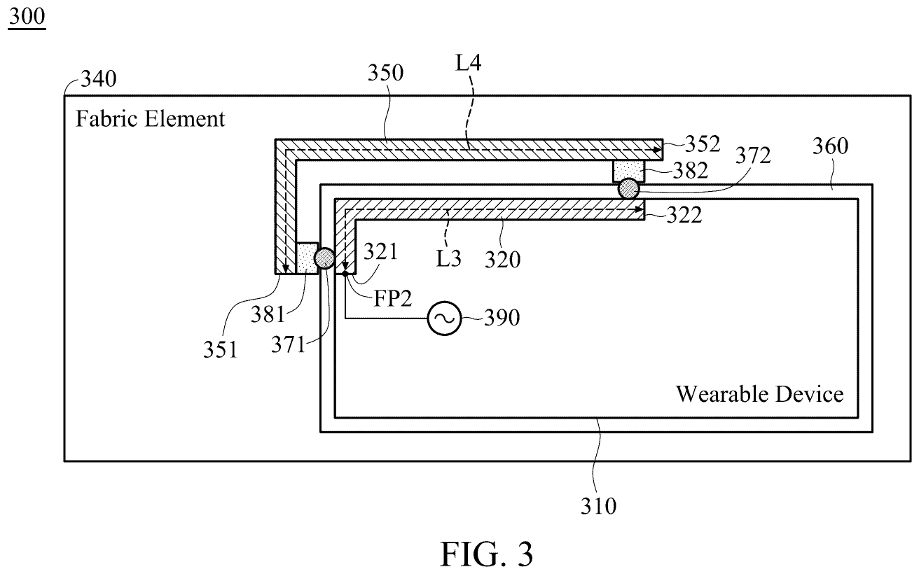

FIG. 3 is a diagram of a communication device 300 according to an embodiment of the invention. FIG. 3 is similar to FIG. 1. In the embodiment of FIG. 3, the communication device 300 at least includes a wearable device 310, a fabric element 340, an auxiliary radiation element 350, and a second conductive connection element 381. The wearable device 310 includes a main radiation element 320, a first conductive connection element 371, and a signal source 390. For example, the main radiation element 320, the auxiliary radiation element 350, the first conductive connection element 371, and the second conductive connection element 381 may all be made of metal materials.

Specifically, the main radiation element 320 has a first end 321 and a second end 322. A feeding point FP2 is positioned at the first end 321 of the main radiation element 320. The feeding point FP2 may also be coupled to a signal source 390. The auxiliary radiation element 350 is disposed on the fabric element 340. The auxiliary radiation element 350 has a first end 351 and a second end 352. In some embodiments, the wearable device 310 further includes a nonconductive frame 360. The main radiation element 320 is attached to an inner side of the nonconductive frame 360. The auxiliary radiation element 350 is arranged toward an outer side of the nonconductive frame 360.

The first conductive connection element 371 is coupled to the first end 321 of the main radiation element 320. For example, the first conductive connection element 371 may be implemented with a metal spring, but it is not limited thereto. The second conductive connection element 381 is disposed on the fabric element 340, and is coupled to the first end 351 of the auxiliary radiation element 350. For example, the second conductive connection element 381 may be implemented with a metal pad, but it is not limited thereto. When the wearable device 310 is integrated with the fabric element 340, the second conductive connection element 381 is coupled to the first conductive connection element 371. Since the first conductive connection element 371 directly touches the second conductive connection element 381, the main radiation element 320 is coupled to the auxiliary radiation element 350, and an antenna structure of the communication device 300 can also cover the low frequency band and the high frequency band as mentioned above. For example, the length L3 of the main radiation element 320 may be from 0.125 to 0.5 wavelength (λ/8~λ/2) of the high frequency band of the antenna structure of the communication device 300, and the length L4 of the auxiliary radiation element 350 may be from 0.125 to 0.5 wavelength (λ/8~λ/2) of the low frequency band of the antenna structure of the communication device 300. According to practical measurements, such a directly-touching design can increase the stability of the antenna structure of the communication device 300, thereby improving the communication quality thereof.

In alternative embodiments, the wearable device 310 further includes a third conductive connection element 372, and the communication device 300 further includes a fourth conductive connection element 382 disposed on the fabric element 340. For example, the third conductive connection element 372 may be implemented with another metal spring, and the fourth conductive connection element 382 may be implemented with another metal pad, but they are not limited. The third conductive connection element 372 is coupled to the second end 322 of the main radiation element 320. The fourth conductive connection element 382 is coupled to the second end 352 of the auxiliary radiation element 350. When the wearable device 310 is integrated with the fabric element 340, the third conductive connection element 372 directly touches the fourth conductive connection element 382, so as to further increase the stability of the antenna structure of the communication device 300. It should be understood that the real positions of the first conductive connection element 371, the second conductive connection element 381, the third conductive connection element 372, and the fourth conductive connection element 382 are adjustable according to different requirements. In other embodiments, the nonconductive frame 360 of the wearable device 310 further has a plurality of openings, and the first conductive connection element 371 and the third conductive connection element 372 are embedded in the aforementioned openings of the nonconductive frame 360. Other features of the communication device 300 of FIG. 3 are similar to those of the communication device 100 of FIG. 1. Accordingly, the two embodiments can achieve similar levels of performance.

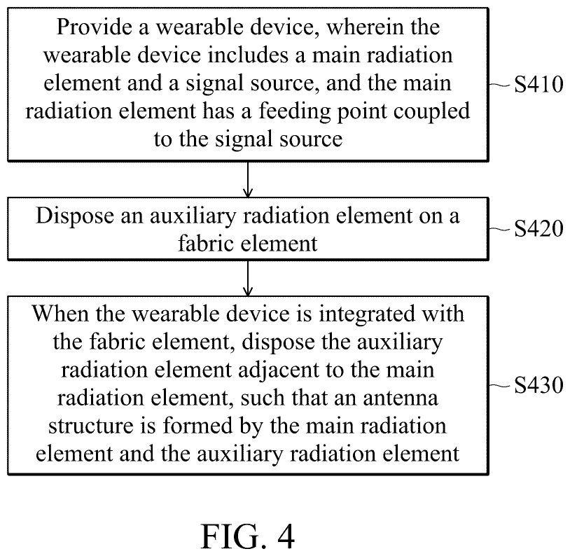

FIG. 4 is a flowchart of a communication method according to an embodiment of the invention. To begin, in step S410, a wearable device is provided. The wearable device includes a main radiation element and a signal source. The main radiation element has a feeding point coupled to the signal source. In step S420, an auxiliary radiation element is disposed on a fabric element. Finally, in step S430, when the wearable device is integrated with the fabric element, the auxiliary radiation element is disposed adjacent to the main radiation element, such that an antenna structure is formed by the main radiation element and the auxiliary radiation element. It should be understood that these steps are not required to be performed in order, and every feature of the embodiments of FIGS. 1-3 may be applied to the communication method of FIG. 4.

The invention proposes a novel communication device. According to practical measurements, the communication device using the above design can significantly improve the overall operational bandwidth of its antenna structure. Therefore, the invention is suitable for application in a variety of equipment.

Note that the above element sizes are not limitations of the invention. A designer can fine-tune these setting values according to different requirements. It should be understood that the communication device and the communication method of the invention are not limited to the configurations of FIGS. 1-4. The invention may include any one or more features of any one or more embodiments of FIGS. 1-4. In other words, not all of the features displayed in the figures should be implemented in the communication device and the communication method of the invention.

The method of the invention, or certain aspects or portions thereof, may take the form of program code (i.e., executable instructions) embodied in tangible media, such as floppy diskettes, CD-ROMS, hard drives, or any other machine-readable storage medium, wherein, when the program code is loaded into and executed by a machine such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine such as a computer, the machine becomes an apparatus for practicing the disclosed methods. When implemented on a general-purpose processor, the program code combines with the processor to provide a unique apparatus that operates analogously to application-specific logic circuits.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

It will be apparent to those skilled in the art that various modifications and variations can be made in the invention. It is intended that the standard and examples be considered as exemplary only, with a true scope of the disclosed embodiments being indicated by the following claims and their equivalents.

What is claimed is:

1. A communication device, comprising:
a wearable device, comprising a main radiation element and a signal source, wherein the main radiation element has a feeding point coupled to the signal source;
a fabric element; and
an auxiliary radiation element, disposed on the fabric element, wherein when the wearable device is integrated with the fabric element, the auxiliary radiation element is adjacent to the main radiation element, such that an antenna structure is formed by the main radiation element and the auxiliary radiation element.

2. The communication device as claimed in claim 1, wherein the wearable device is an XR (Extended Reality) computing device.

3. The communication device as claimed in claim 1, wherein the fabric element is an article of clothing.

4. The communication device as claimed in claim 1, wherein the antenna structure covers a low frequency band and a high frequency band.

5. The communication device as claimed in claim 4, wherein the low frequency band is from 700 MHz to 1000 MHz.

6. The communication device as claimed in claim 4, wherein the high frequency band is from 2400 MHz to 7125 MHz.

7. The communication device as claimed in claim 4, wherein a length of the main radiation element is from 0.125 to 0.5 wavelength of the high frequency band.

8. The communication device as claimed in claim 4, wherein a length of the auxiliary radiation element is from 0.125 to 0.5 wavelength of the low frequency band.

9. The communication device as claimed in claim 1, wherein the main radiation element substantially has a short L-shape.

10. The communication device as claimed in claim 1, wherein the auxiliary radiation element substantially has a long L-shape.

11. The communication device as claimed in claim 1, wherein a coupling gap is formed between the main radiation element and the auxiliary radiation element.

12. The communication device as claimed in claim 11, wherein a width of the coupling gap is from 0.5 mm to 2 mm.

13. The communication device as claimed in claim 1, wherein the wearable device further comprises a tuning circuit, and the feeding point is further coupled through the tuning circuit to the signal source.

14. The communication device as claimed in claim 13, wherein the tuning circuit is configured to improve impedance matching of the antenna structure.

15. The communication device as claimed in claim 1, wherein the wearable device further comprises a first conductive connection element coupled to the main radiation element.

16. The communication device as claimed in claim 15, wherein the first conductive connection element is implemented with a metal spring.

17. The communication device as claimed in claim 15, further comprising:
a second conductive connection element, disposed on the fabric element, and coupled to the auxiliary radiation element.

18. The communication device as claimed in claim 17, wherein the second conductive connection element is implemented with a metal pad.

19. The communication device as claimed in claim 17, wherein when the wearable device is integrated with the fabric element, the second conductive connection element is coupled to the first conductive connection element.

20. A communication method, comprising the steps of:
providing a wearable device, wherein the wearable device comprises a main radiation element and a signal source, and the main radiation element has a feeding point coupled to the signal source;
disposing an auxiliary radiation element on a fabric element; and
when the wearable device is integrated with the fabric element, disposing the auxiliary radiation element adjacent to the main radiation element, such that an antenna structure is formed by the main radiation element and the auxiliary radiation element.
